(19) United States
(12) Patent Application Publication
(10) Pub. No.: US 2003/0142248 A1
(43) Pub. Date: Jul. 31, 2003

(54) Liquid crystal display device and method for manufacturing the same

(76) Inventors: Tae Kyu Park, Kyoungki-do (KR); Sung Hun Song, Kyoungki-do (KR); Sung Woon Kim, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/317,794

(22) Filed: Dec. 12, 2002

(30) Foreign Application Priority Data
Jan. 29, 2002 (KR) 2002-5077

(51) Int. Cl. G02F 1/1333

(52) U.S. Cl. 349/86

(57) ABSTRACT

Disclosed is a liquid crystal display device and method for manufacturing the same. The method comprises the steps of: preparing a transparent insulation substrate; forming a black matrix on the substrate and then forming a color filter layer on the black matrix; forming an indium tin oxide (ITO) or overcoating layer on the color layer; forming a pattern of post spacers on the ITO or overcoating layer; and forming a liquid crystal layer on the substrate by means of polymer dispersed liquid crystal. According to the present invention, the need for polyimide (PI) coating and rubbing processes can be obviated by using a post spacer color filter having a uniform cell gap and by using a polymer dispersed liquid crystal (PDLC), and the time for injecting liquid crystal can be decreased by using a one-drop filling (ODF) approach. Therefore, it has an improved screen grade, a decreased processing step and a cost-effective processing step.

### BACKGROUND OF THE INVENTION

1. Field of the Invention

The present invention relates to a liquid display device and method for manufacturing the same. More particularly, the present invention is directed to improve a screen grade by means of change in structure or material for a post spacer color filter.

2. Description of the Prior Art

In the conventional liquid display device and the method for manufacturing the same, employing a post spacer color filter generally used nowadays, as shown in FIG. 1, a glass substrate 1 undergoes formation, in turn, of a black matrix 3 thereon, of a color filter 5 consisting of Red, Green and Blue pigments, and of an indium tin oxide (ITO) layer (not shown) or an overcoating layer (not shown), wherein the ITO layer is for a mode using a vertical electric field, such as a twisted nematic (TN) mode, and the overcoating layer is for a mode using a parallel electric field, such as a fringe-field switching (FFS) or in-plane switching (IPS). Then, a photoresist is applied on the ITO or overcoating layer, and exposed to light in the presence of a patterned mask, thus forming post spacers 7.

According to this device and method of the prior art, the interval of the patterned post spacers is too wide and their dimensions are too small. Therefore, when a certain part of the post spacers has a breakage or defect, the part has a cell gap which is different from that of the other parts. This difference between cell gaps led to a defect in that a dapple was observed through a panel.

To resolve this problem, as shown in FIG. 2, it has been proposed in another prior invention that post spacers 17 be formed throughout the entire area of a black matrix 13 on a substrate 10. Here, arrangement of the post spacers 17 might be changed under consideration of a rubbing direction and of a direction of a liquid crystal injection opening, as shown in FIGS. 2B and 2C.

However, there is a problem in the prior invention mentioned immediately above as follows.

Even though the post spacers are designed to be disposed in one direction depending on the processing direction in a polyimide (PI) coating or rubbing process, the area of the post spacers is too large. Therefore, there is a possibility of generating scratches or coating defects by a height difference between the post spacers during processing. Also, since passways, through which the liquid crystal flows, are blocked on at least one side by the post spacers, it is difficult for the liquid crystal to flow during injection of liquid crystal.

### SUMMARY OF THE INVENTION

Accordingly, the present invention has been made to solve the above-mentioned problems occurring in the prior art, and an object of the present invention is to provide a liquid crystal display device and a method for manufacturing the same which employ post spacers, each of which is formed with grooves around the four sides thereof so as to cause a liquid crystal to flow smoothly.

Another object of the present invention is to provide a liquid crystal display device and method for manufacturing the same capable of preventing defects in polyimide (PI) coating and of preventing scratches by using a polymer dispersed liquid crystal (PDLC) consisting of a mixture of a polymer with liquid crystal, and capable of decreasing the number of manufacturing steps.

In order to accomplish these objects, a method for manufacturing a liquid crystal display device according to a first embodiment of the present invention comprises the steps of: preparing a transparent insulation substrate; forming a black matrix on the substrate and then forming a color filter layer on the black matrix; forming an indium tin oxide (ITO) or overcoating layer on the color layer; forming a pattern of post spacers on the ITO or overcoating layer; and forming a liquid crystal layer on the substrate by means of polymer dispersed liquid crystal.

Furthermore, a liquid crystal display device according to a first embodiment of the present invention comprises: a transparent insulation substrate; a black matrix and a color filter layer formed on the substrate in that order; an indium tin oxide (ITO) or overcoating layer formed on the color filter layer; a pattern of post spacers formed on the ITO or overcoating layer; and a liquid crystal layer formed on the substrate.

In order to accomplish these objects, the method for manufacturing a liquid crystal display device according to a second embodiment of the present invention comprises the steps of: preparing a transparent insulation substrate; forming a plurality of black matrixes on the substrate and then forming a plurality of color filter layers flush with and between the black matrixes; forming a pattern of post spacers on the black matrixes and the color filter layers; and forming a liquid crystal layer on the substrate by means of polymer dispersed liquid crystal.

Further, the liquid crystal display device according to a second embodiment of the present invention comprises: a transparent insulation substrate; a black matrix and a color filter layer formed on the substrate flush with each other; a pattern of post spacers formed on the black matrix and the color filter layer; and a liquid crystal layer formed on the substrate by means of polymer dispersed liquid crystal.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are plan views for describing a liquid crystal display device and a method for manufacturing the same according to the prior art;

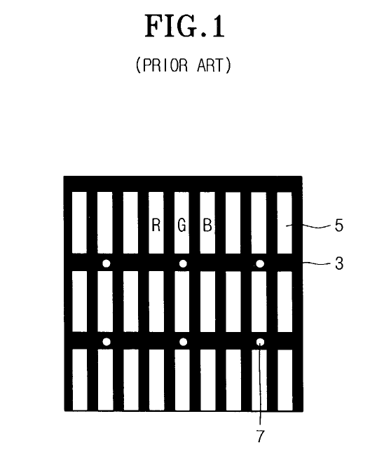

FIG. 3 is a cross-sectional view for describing a liquid crystal display device and a method for manufacturing the same according to a first embodiment of the present invention;

FIG. 4 is a is plan view for describing a liquid crystal display device and a method for manufacturing the same according to a first embodiment of the present invention;

FIG. 5 is a cross-sectional view for describing a driving principle of a polymer dispersed liquid crystal (PDLC) in a liquid crystal display device and a method for manufacturing the same according to a first embodiment of the present invention; and

FIG. 6 is a cross-sectional view for describing a liquid crystal display device and a method for manufacturing the same according to a second embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

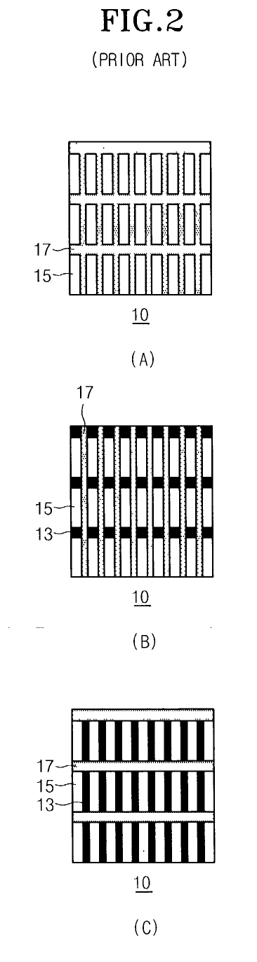

In a method for manufacturing a liquid crystal device according to a first embodiment of the present invention, as shown in FIG. 3, a black matrix 110 of resin or chrome (Cr) is formed on a transparent insulation substrate 100 such as glass. Then, a color filter layer 120, consisting of a red layer 120a, a green layer 120b and a blue layer 120c, is formed on the black matrix 110.

Next, an indium tin oxide (ITO) or overcoating layer 130 is formed on the color filter layer 120. In this case, the ITO layer 130 is formed by a mode such as a twisted nematic (TN) mode using a vertical electric field, and the overcoating layer 130 is formed by a mode such as a fringe-field switching (FFS) or in-plane switching (IPS) mode using a parallel electric field.

Subsequently, a photoresist is applied on the ITO/overcoating layer 130, and then exposed in the presence of a patterned mask to form post spacers 140. Here, the post spacers 140 have a thickness or height ranging from approximately 2 to 10 microns.

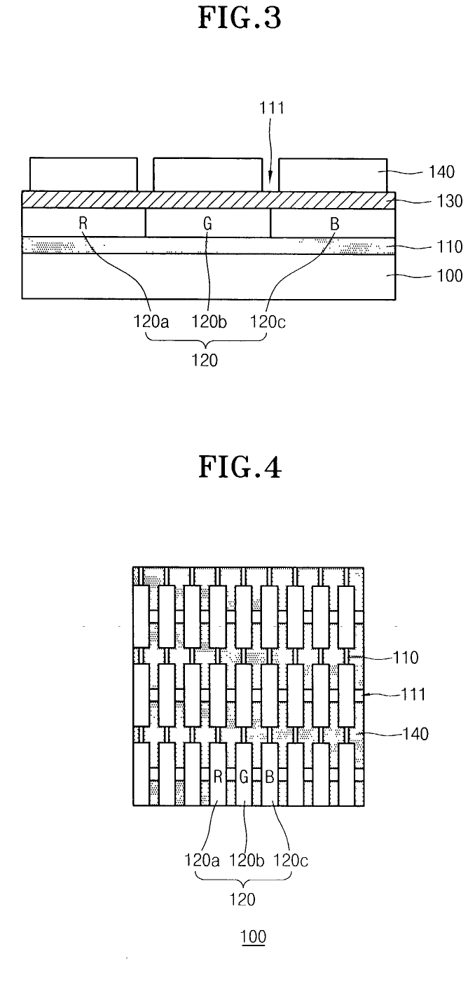

Meanwhile, when the red layer 120a, green layer 120b and blue layer 120c are each defined into sub-pixels, the post spacers 140 are formed around the four sides of each sub-pixel as shown in FIG. 4.

A structure of the substrate 100 formed as mentioned above is similar to one in which grooves 111 are engraved to connect the middles of the four sides of each sub-pixel with adjacent facing middles of other sides of other sub-pixel. The grooves are formed by spaces or passways between post spacers, and are so formed that the length of the grooves does not exceed a size of a sub-pixel, within about 1 micron.

Then, though not shown in drawings, the resulting substrate 100 is subjected to injection of liquid crystal so as to form liquid crystal layer across the entire structure thereof, and bonded together with another substrate with a switching device such as a thin film transistor (TFT). Then, an overcoating layer is covered on the substrate with the TFT. The entire substrate is preferably subjected to planarization so that it has a high compatibility with the color filter in which post spacers have a large area.

Further, it is preferred that polymer dispersed liquid crystal (PDLC), in which polymer and liquid crystal are mixed and dispersed, is used for the liquid crystal layer. This is based on the fact in that a polyimide (PI) coating failure or a scratch can be prevented, which may be generated during a subsequent PI coating or rubbing process, resulting from height differences. Specifically, since the PDLC is mixed with polymer and liquid crystal at a constant rate, the liquid crystal is capable of being aligned or driven without PT coating and aligning processes.

Also, it is preferred that the liquid crystal layer is formed in a one-drop filling approach, because this approach facilitates a smooth flow of the liquid crystal to form a uniform cell gap.

A liquid crystal display device of the present invention includes a black matrix, a color filter layer, an ITO or overcoating layer and post spacers, all of which are disposed on a transparent insulation substrate. Further, a liquid crystal layer is formed in a one-drop filling approach, and consists of polymer dispersed liquid crystal (PDLC) in which polymer and liquid crystal are mixed at a constant rate.

One substrate (upper substrate), provided with the color filter, is bonded with the other substrate (lower substrate) having a switching device and an ITO or transparent conductive layer. A liquid crystal layer is interposed between two substrates. The lower substrate is formed with an overcoating layer on the top surface thereof so as to perform planarization, so that it has a high compatibility with a color filter in which post spacers have a large area.

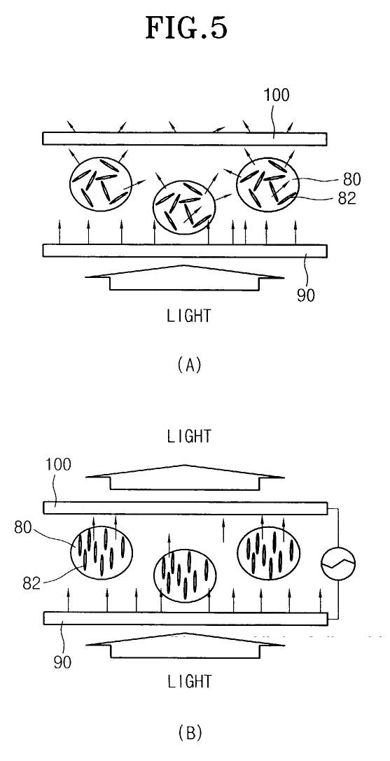

As shown in FIG. 5, when the liquid crystal display device constructed as above is not powered (see FIG. 5A), the device can not present images by scattering light. In contrast, when the device is powered (see FIG. 5B), the device can present certain images by regularly arranging the liquid crystal 82 in a certain direction along with an electric field established within the polymer, and by transmitting light upwardly.

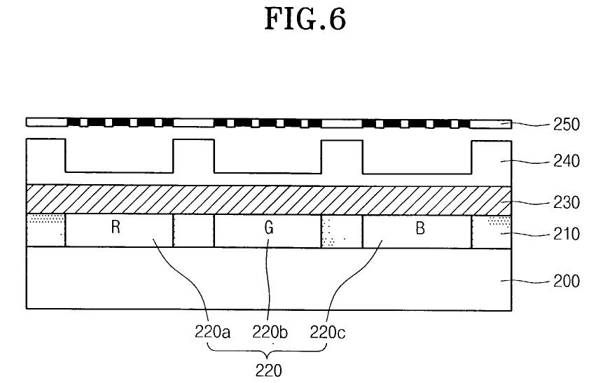

In a method for manufacturing a liquid crystal display device according to a second embodiment of the present invention, as shown in FIG. 6, a black matrix 210 of resin or chrome (Cr) is formed on a transparent insulation substrate 200 such as glass. Then, a color filter layer 220, consisting of a red layer 220a, a green layer 220b and a blue layer 220c, is formed within and flush with the black matrix 210.

Next, a transparent conductive layer 230 such as an ITO is formed on the black matrix 210 and the color filter layer 220, in a mode using a vertical electric field. However, such a transparent conductive layer 230 is not formed in a mode using a horizontal electric field.

Subsequently, a photoresist acting as an alignment layer is applied on the transparent conductive layer 230, and then exposed to light in the presence of a half tone mask to form post spacers 240. The post spacers 240, through the properties of their materials, have a double function as an alignment layer as well as an overcoating layer.

Herein, the detailed description on the other processes will be omitted, because they are the same as those of the first embodiment.

Similarly, a liquid crystal display device according to a second embodiment of the present invention has the same construction and operation as that of the first embodiment of the present invention except for position of the black matrix and color filter layer. Therefore, its detailed description will be also omitted.

As seen from the above, a liquid crystal display device and method for manufacturing the same according to preferred embodiments of the present invention can obtain effects as following.

The present invention can not only obviate the need for the polyimide (PT) coating and rubbing processes by using a post spacer color filter having a uniform cell gap and by using a polymer dispersed liquid crystal (PDLC), but also decrease the time for injecting liquid crystal by using a one-drop filling (ODF) approach. Therefore, it has an improved screen grade, a decreased processing step and a cost-effective processing step.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing a liquid crystal display device, comprising the steps of:
preparing a transparent insulation substrate;
forming a black matrix on the substrate and then forming a color filter layer on the black matrix;
forming an indium tin oxide (ITO) or overcoating layer on the color layer;
forming a pattern of post spacers on the ITO or overcoating layer; and
forming a liquid crystal layer on the substrate by means of polymer dispersed liquid crystal.

2. A method as claimed in claim 1, wherein the pattern of post spacers takes a form in that the post spacers surround the four sides of each sub-pixel forming the color filter layer and in that grooves are engraved to connect each middle of each of the sides of the sub-pixels with an adjacent facing middle of each of the sides of the sub-pixels.

3. A method as claimed in claim 2, wherein the grooves have a size of about 1 micron or the same size as the sub-pixels.

4. A method as claimed in claim 1, wherein the pattern of post spacers is formed at a height of about 2 to 10 microns.

5. A method as claimed in claim 1, wherein the liquid crystal layer is formed in a one-drop filling approach.

6. A liquid crystal display device, comprising:
a transparent insulation substrate;
a black matrix and a color filter layer formed on the substrate in that order;
an indium tin oxide (ITO) or overcoating layer formed on the color filter layer;
a pattern of post spacers formed on the ITO or overcoating layer; and
a liquid crystal layer formed on the substrate.

7. A liquid crystal display device as claimed in claim 6, wherein the pattern of post spacers takes a form in that the post spacers surround the four sides of each sub-pixel forming the color filter layer and in that grooves are engraved to connect each middle of each of the sides of the sub-pixels with an adjacent facing middle of each of the sides of the sub-pixels.

8. A liquid crystal display device as claimed in claim 7, wherein the grooves have a size of about 1 micron or the same size as the sub-pixels.

9. A liquid crystal display device as claimed in claim 6, wherein the pattern of post spacers is formed at a height of about 2 to 10 microns.

10. A method for manufacturing a liquid crystal display device, comprising the steps of:
preparing a transparent insulation substrate;
forming a plurality of black matrixes on the substrate and then forming a plurality of color filter layers flush with and between the black matrixes;
forming a pattern of post spacers on the black matrixes and the color filter layers; and
forming a liquid crystal layer on the substrate by means of polymer dispersed liquid crystal.

11. A method as claimed in claim 10, further comprising the step of forming a transparent conductive layer on the black matrixes and the color filter layers.

12. A method as claimed in claim 10, wherein the pattern of post spacers is formed by means of a photoresist having an alignment function.

13. A method as claimed in claim 10, wherein the pattern of post spacers is formed at a height of about 2 to 10 microns.

14. A method as claimed in claim 10, wherein the liquid crystal layer is formed in a one-drop filling approach.

15. A liquid crystal display device, comprising:
a transparent insulation substrate;
a black matrix and a color filter layer formed on the substrate flush with each other;
a pattern of post spacers formed on the black matrix and the color filter layer; and
a liquid crystal layer formed on the substrate by means of polymer dispersed liquid crystal.

16. A method as claimed in claim 15, further comprising the step of forming a transparent conductive layer on the black matrix and the color filter layer.

17. A liquid crystal display device as claimed in claim 6, wherein the pattern of post spacers is formed at a height of about 2 to 10 microns.

18. A method as claimed in claim 10, wherein the pattern of post spacers is formed by means of a photoresist having an alignment function.
